(19) United States
(12) Patent Application Publication
(10) Pub. No.: US 2013/0092537 A1
(43) Pub. Date: Apr. 18, 2013

(54) GAS SENSOR ELEMENT AND GAS SENSOR

(71) Applicants: Keigo MIZUTANI, Okazaki-shi (JP); Norikazu KAJIYAMA, Chiryu-shi (JP)

(72) Inventors: Keigo MIZUTANI, Okazaki-shi (JP); Norikazu KAJIYAMA, Chiryu-shi (JP)

(73) Assignee: DENSO CORPORATION, Kariya-city (JP)

(21) Appl. No.: 13/644,486

(22) Filed: Oct. 4, 2012

(30) Foreign Application Priority Data
Oct. 13, 2011 (JP) 2011-225643

(51) Int. Cl. G01N 27/41

(52) U.S. Cl. 204/427

(57) ABSTRACT

The gas sensor element includes an inner space into which a measurement gas is introduce through a diffusion resistor, a first oxygen pump cell, a second oxygen pump cell and a sensor cell. One of the electrodes formed on the opposite surfaces of the solid electrolyte body of the first oxygen pump cell and one of the electrodes formed on the opposite surfaces of the second oxygen pump cell are disposed opposite to each other across from the inner space. The other electrode of the first oxygen pump cell and the other electrode of the second oxygen pump cell are exposed to a common reference oxygen concentration gas.

This application claims priority to Japanese Patent Application No. 2011-225643 filed on Oct. 13, 2011, the entire contents of which are hereby incorporated by reference.

### BACKGROUND OF THE INVENTION

1. Field of the Invention

The present invention relates to a gas sensor element for measuring concentration of a specific gas such as NOx (nitrogen oxide), and a gas sensor including the gas sensor element which can be used for an exhaust gas purifying system of a vehicle having an internal combustion engine.

2. Description of Related Art

Air pollution due to exhaust gases discharged from vehicle-use internal combustion engines is becoming significant, and accordingly regulations for regulating purification of pollution substance such as NOx are becoming strict in recent years. It is thought that exhaust gas purification can be performed efficiently by measuring concentration of NOx contained in exhaust gas, and feed-backing result of the measurement to an engine combustion control monitor, a catalyst monitor, or the like. From such a point of view, there has been a demand of a gas sensor element capable of measuring NOx concentration of exhaust gas with a high degree of accuracy.

Japanese Patent No. 2885336 (Patent document 1 hereinafter) describes such a gas sensor element. As shown in FIG. 8, this gas sensor element 100 includes first and second electrochemical pump cells 105 and 107 and an electrochemical sensor cell 106. The detailed structure of this gas sensor cell 100 is explained below. The gas sensor element 100 is formed with, at its distal end portion, a first inner empty space 102 disposed below a first diffusion resistor 101 and a second inner empty space 104 in communication with the first inner empty space 102 through a second diffusion resistor 103. A gas containing NOx is introduced into the first inner empty space 102 from a measurement gas-existing space.

The first electrochemical pump cell 105 is disposed facing the first inner empty space 102. When the first electrochemical pump cell 105 is applied with a voltage, oxygen present in the first inner empty space 102 is pumped out of the gas sensor element 100, or oxygen present outside the gas sensor element 100 is pumped into the first inner empty space 102. The electrochemical sensor cell 106 is for measuring the oxygen concentration in the first inner empty space 102. The first electrochemical pump cell 105 is feedback-controlled so that the oxygen concentration in the first inner empty space 102 measured by the electrochemical sensor cell 106 is kept constant.

The second electrochemical pump cell 107 is disposed inside the second inner empty space 104 to enable measuring NOx concentration by measuring the concentration of oxygen ions produced front NOx. The amount of oxygen ions moving when the second electrochemical pump cell 107 is applied with a predetermined voltage, that is, the magnitude of the oxygen ion current in the second electrochemical pump cell 107 corresponds to the NOx concentration to be measured.

Meanwhile, there is known the urea SCR (Selective Catalytic Reduction) system as an exhaust gas purifying system using a catalyst. The urea SCR system which is one of measures for decreasing NOx in exhaust gas, operates to produce NH₃ (ammonia) as a reducing agent by injecting urea-water into an exhaust gas to reduce NOx into harmless N₂ and H₂O by selective catalytic reduction. However, if the amount of the injected urea-water is too much for the amount of NOx to be reduced, harmful NH₃ is discharged. Accordingly, it is necessary to control the amount of urea-water injected into the exhaust gas at an optimum value.

As shown in FIG. 3B, if injected urea-water is insufficient for NOx to be reduced, NOx is discharged, and if injected urea-water is excessive for NOx to be reduced, NH₃ is discharged.

Accordingly, the urea SCR system needs to feedback-control an injection amount of urea-water so that the NOx concentration and the NH₃ concentration in the post-catalyst stream in order to realize an optimum exhaust gas purification.

From such a point of view, there is a demand of a gas sensor element capable of measuring, in addition to NOx concentration, NH₃ concentration in exhaust gas with a high degree of accuracy.

Japanese Patent Application Laid-open No. 2007-108018 (Patent document 2 hereinafter) describes a gas analyzing apparatus capable of calibrating NOx sensitivity for the purpose of increasing measuring accuracy of its gas sensor element. This gas analysing apparatus includes a NOx sensor having first and second space sections and first to third pump electrodes, and is configured to calibrate the NOx sensitivity using a calibration gas. In this apparatus, a relationship between an oxygen gas-dependency and a NOx gas-dependency of a pump current of the third pump cell is measured in advance, and the NOx sensitivity is calibrated using an oxygen gas as a calibration gas. Accordingly, the NOx sensor of this apparatus can be calibrated on-site even when NOx gas is not available.

Japanese Patent No. 3607453 (Patent document 3 hereinafter) describes a gas sensor including first and second oxygen pump cells disposed inside a sample gas chamber, and a detection cell. One of the electrodes of the first and second pump cells is disposed facing the sample gas chamber. The other electrode faces an open chamber which faces the space inside the element cover through which a sample gas flows or an open chamber opening to this space. By enhancing capacity of evacuating oxygen from the sample gas chamber by using the two oxygen pump cells, it possible to reduce the oxygen concentration in the sample gas chamber to nearly 0, to thereby increase the NOx sensitivity.

The gas sensor element 100 described in Patent document 1 is controlled such that the oxygen concentration in the first inner empty space 102 is kept constant, and accordingly NH₃ is converted into NO within the inner empty space 102. Therefore, it is possible to measure the sum amount of NOx produced from NH₃ and NOx contained in the measurement gas when NOx and NH₃ coexist. At this time, it does not necessarily have to make a distinction between the NOx concentration and the NH₃ concentration using a sensor signal, because it is possible to determine an optimum control point based on the fact that the sensor output decreases with the increase of an injection amount of urea water in the NOx discharge range, and increases with the increase of an injection amount of urea water in the NH₃ discharge range.

However, if there is element-to-element variation in the shape of at least one of the first and second diffusion resistors 101 and 103 and the inner empty spaces 102 and 104, the current sensitivity of the second electrochemical, pump cell 107 with respective to NOx gas varies. Accordingly, it is necessary to calibrate every sensor element by measuring the current of the second electrochemical pump cell 107 for predetermined concentration of harmful and expensive NOx gas. This leads to increase of the manufacturing cost of the sensor element.

The NOx sensor described in Patent document 2 can be calibrated not using harmful and expensive NOx gas but using oxygen gas of a predetermined concentration as the calibration gas. However, it is necessary to measure a relationship between the NOx-concentration dependency and the oxygen concentration-dependency using NOx gas of a predetermined concentration for every sensor. Further, since it is necessary to prepare oxygen gas of a concentration comparable with concentration of NOx gas to be measured, a substantial cost, reduction cannot be expected.

The gas sensor described in Patent document 3 cannot be used for precise control of oxygen concentration, because the other electrodes of the first and second oxygen pumps are exposed to the sample gas, and accordingly their voltages are not stable. Further, the gas sensor is assumed to be used in a lean atmosphere, and is hard to operate in a rich atmosphere because oxygen gas cannot be supplied into the sample gas chamber in a rich atmosphere.

### SUMMARY

An exemplary embodiment provides a gas sensor element including:

an inner space into which a measurement gas is introduced through a diffusion resistor;

a first oxygen pump cell including a first solid electrolyte body having oxygen ion conductivity, and first and second electrodes formed on both opposite surfaces of the first solid electrolyte body, the first electrode facing the inner surface so that oxygen can be introduced into or discharged from the inner space to adjust oxygen concentration in the inner space by applying a voltage between the first and second electrodes;

a second oxygen pump cell including a second solid electrolyte body having oxygen ion conductivity, and third and fourth electrodes formed on both opposite surfaces of the second solid electrolyte body, the third electrode facing the inner surface so that oxygen can be introduced into or discharged from the inner space to adjust the oxygen concentration in the inner space by applying a voltage between the third and fourth electrodes; and

a sensor cell including a third solid electrolyte body having oxygen ion conductivity, and fifth and sixth electrodes formed on both opposite surfaces of the third solid electrolyte body, the fifth electrode facing the inner surface, a current flowing between the fifth and sixth electrode being an output of the gas sensor element indicative of concentration of a specific gas component contained in the measurement gas;

wherein

the first electrode and the third electrode are disposed opposite to each other across from the inner space, and

the second electrode and fourth electrode are exposed to a common reference oxygen concentration gas.

According to the exemplary embodiment, there are provided a gas sensor element and a gas sensor including the gas sensor element for measuring concentration of specific gas component such as NOx contained in an exhaust gas, for example, of an internal combustion engine mounted on a vehicle, the gas sensor element having small element-to-element variation in measuring sensitivity due to element-to-element variation in its component shape, being easy to calibrate the measuring sensitivity, being operable in both a rich atmosphere and a lean atmosphere, and satisfying both a high measurement accuracy and a low manufacturing cost.

Other advantages and features of the invention will become apparent from the following description including the drawings and claims.

### BRIEF DESCRIPTION OF THE DRAWINGS

In the accompanying drawings:

FIG. 1A is a schematic cross-sectional view of a distal end portion of a gas sensor element according to a first embodiment of the invention; FIG. 1B is an entire cross-sectional view of a NOx sensor including the gas sensor element according to the first embodiment;

FIG. 2 is an exploded development view of the gas sensor element according to the first embodiment;

FIG. 3A is a diagram showing an overall structure of a exhaust gas purifying system including a urea SCR system including the NOx sensor mounted on a exhaust system of a vehicle's internal combustion engine; FIG. 3B is a diagram showing a relationship between an addition amount of urea and NH₃ concentration in the urea SCR system;

FIG. 4A is a diagram showing a relationship between the pump cell current and the sensor cell current of the gas sensor element according to the first embodiment;

FIG. 4B is a diagram showing a relationship between the height of the inner space and the sensor cell current of the gas sensor element according to the first embodiment;

FIG. 5 is a diagram showing variation with time of the sensor output of a conventional gas sensor element during transition from rich atmosphere to lean atmosphere;

FIG. 6 is a diagram showing variation with time of the sensor output of the gas sensor element according to the first embodiment during transition from rich atmosphere to lean atmosphere;

FIG. 7 is a schematic cross-sectional view of the distal end portion of a gas sensor element according to a second embodiment of the invention; and

FIG. 8 is a schematic cross-sectional view of a distal end portion of the conventional gas sensor element.

### PREFERRED EMBODIMENTS OF THE INVENTION

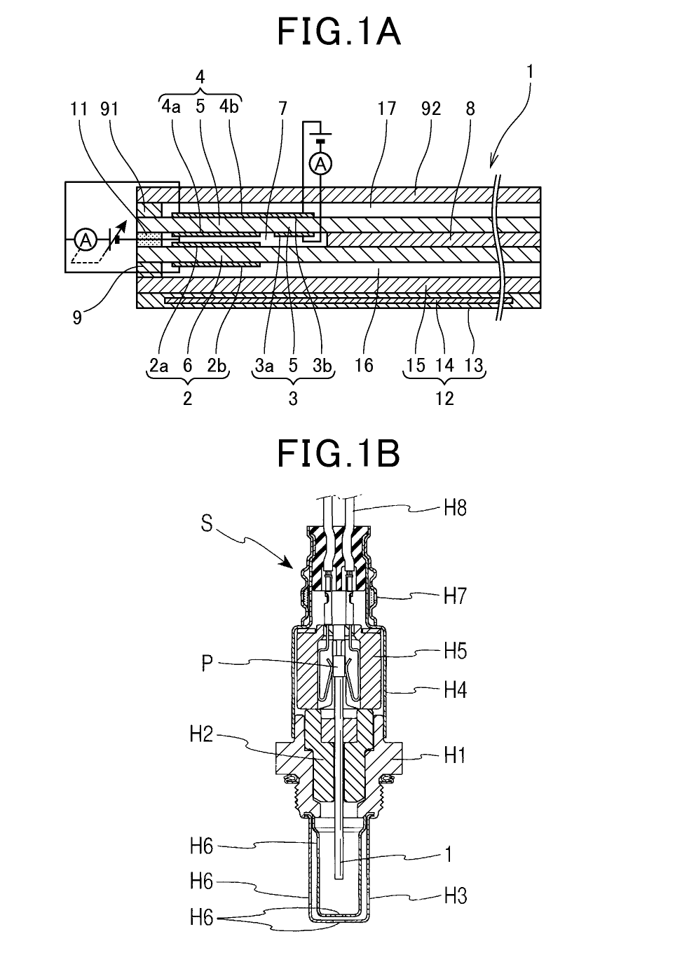

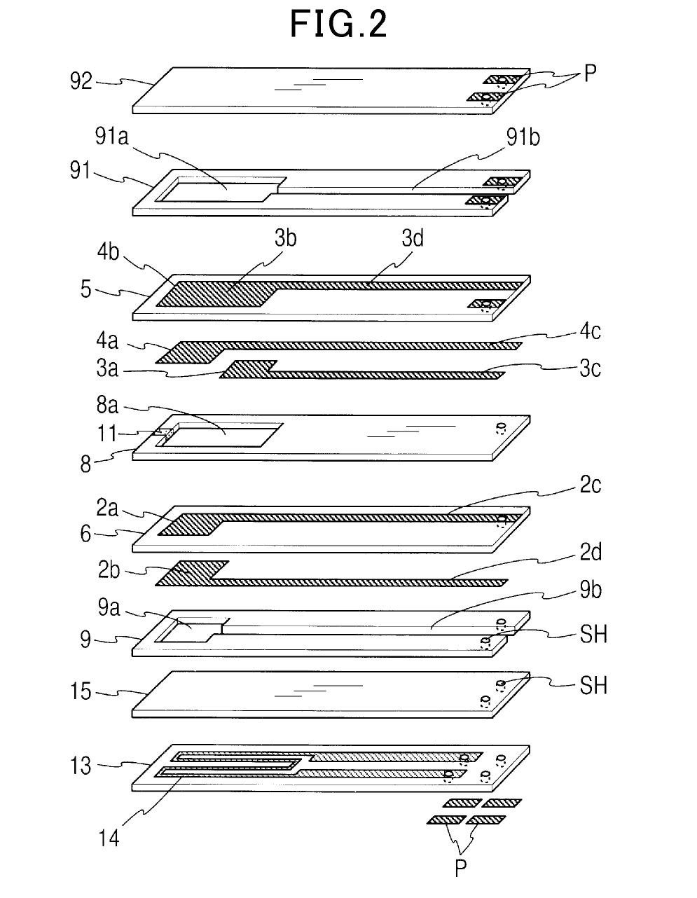

FIG. 1A is a schematic cross-sectional view of a distal end portion of a gas sensor element 1 according to a first embodiment of the invention. FIG. 2 is an exploded development view of the gas sensor element 1. FIG. 1B is an entire cross-sectional view of a NOx sensor S including the gas sensor element 1. The NOx sensor S is disposed in an exhaust gas passage of an internal combustion engine of a vehicle to measure a specific gas component such as NOx (nitrogen oxide) contained in exhaust gas.

The NOx sensor S includes a cylindrical housing H1 fitted to the wall of an exhaust pipe (not shown), and the gas sensor element 1 insulatively held inside the housing H1. The gas sensor element 1 having a shape of an elongated plate is held inside a cylindrical insulator H2 disposed inside the housing H1 at its center portion. The distal end portion (the lower end portion in FIG. 1B) of the gas sensor element 1 is accommodated within an element cover H3 fixed to the bottom end of the housing H1. The proximal end portion (the upper end portion in FIG. 1B) of the gas sensor element 1 is located within a cylindrical member H4 fixed to the upper end of the housing H1, and is provided with terminals P connected to lead wires H0 drawn outside. Between the cylindrical member H4 and the proximal end portion of the gas sensor element 1, a cylindrical insulator H5 is disposed.

The element cover H3 projecting into the exhaust pipe has a double structure including outer and inner walls each formed with an exhaust hole H6 at its side surface and bottom surface so that the exhaust gas flowing through the exhaust gas passage can be taken inside the element cover H3 as a measurement gas (a gas to be measured) containing a specific gas component. On the other hand, the cylindrical member H4 projecting outside the exhaust pipe is formed with an atmospheric hole H7 at the side surface of the upper end portion thereof so that the atmosphere can be introduced as a reference oxygen concentration gas into the cylindrical insulator H5 in which the proximal end portion of the gas sensor element 1 is located. As described above, the atmosphere can be introduced into the gas sensor element 1 through the space inside the cylindrical insulator H5 as a common reference-oxygen-concentration gas containing space.

As shown in FIG. 1A and FIG. 2, the gas sensor element 1 is formed by stacking, in order, a sheet-like solid electrolyte body 6 for constituting a first oxygen pump cell 2, a sheet-like solid electrolyte body 5 for constituting a second oxygen pump cell 4 and a sensor cell 3, a sheet-like spacer 8 for forming an inner space 7, sheet-like spacers 9 and 91 for forming a first reference gas space 16 and a second reference gas space 17, and a heater 12 for heating these components.

The inner space 7 is a chamber into which the measurement gas is introduced from the measurement gas existing space. As shown in FIG. 2, the inner space 7 is formed of a cut hole 8a formed in the spacer 8 located between the solid electrolyte bodies 5 and 6. In this embodiment, the measurement gas containing space is an inner space of the element cover H3 shown in FIG. 1B, into which the exhaust gas flowing through the exhaust gas passage of the internal combustion engine is introduced. The inner space 7 is in communication with the measurement gas-existing space through a porous diffusion resistor 11. The shape, porosity and porous diameter of the porous diffusion resistor 11 are determined in order that the diffusion speed of the measurement gas introduce into the inner space 7 through the porous diffusion resistor 11 becomes equal to a predetermined speed.

The atmosphere is introduced into the first reference gas space 16 and the second reference gas space 17 as a common reference-concentration oxygen gas. The first reference gas space 16 is formed of a cut hole 9a formed in the spacer 9 stacked below the solid electrolyte body 8. The second reference gas space 17 is formed of a cut hole 91a formed in the spacer 91 stacked above the solid electrolyte body 5. The cut hole 9a includes a passage portion 9b which is a groove extending in the longitudinal direction of the gas sensor element 1. The cut hole 91a includes a passage portion 91b which is a groove extending in the longitudinal direction of the gas sensor element 1. The passage portions 9b and 91b open to the sides of the proximal end portions (the right end portions in FIG. 2) of the spacers 9 and 91, respectively to communicate with the space inside the cylindrical insulator H5, which is a space in which the common reference-concentration oxygen gas exists.

The heater 12 is stacked below the spacer 9, and a sheet 92 made of insulating material is stacked above the spacer 91 to close the upper or lower openings of the cut holes 9a and 91a and passage portions 9b and 91b. Accordingly, the atmosphere is introduced into the first and second reference gas spaces 16 and 17 through the passage portions 9b and 91b, respectively. Each of the spacers 8, 8 and 91 is made of insulating material such as alumina.

Each of the first and second oxygen pump cells 2 and 4 and the solid electrolyte bodies 5 and 6 is made of electrolyte having oxygen-ion conductivity such as zirconia or ceria. The first pump cell 2 is constituted of the solid electrolyte body 6 and a pair of electrodes 2a and 2b disposed so as to sandwich the solid electrolyte body 6. The electrode 2a is formed in contact with the upper surface of the solid electrolyte body 6 so as to face the inner space 7. The electrode 2b is formed in contact with the lower surface of the solid electrolyte body 6 so as to face the first reference gas space 16.

The second pump cell 4 is constituted of the solid electrolyte body 5 and a pair of electrodes 4a and 4b disposed so as to sandwich the solid electrolyte body 5. The electrode 4a is formed in contact with the lower surface of the solid electrolyte body 5 so as to face the inner space 7. The electrode 4b is formed in contact with the tipper surface of the solid electrolyte body 5 so as to face the second reference gas space 17. The electrode 4a of the second oxygen pump cell 4 and the electrode 2a of the first oxygen pump cell 2 are disposed at opposite positions (vertically opposite positions in FIG. 1A) across the inner space 7.

The sensor cell 3 is constituted of the solid electrolyte body 5 and a pair of electrodes 3a and 3b disposed so as to sandwich the solid electrolyte body 5, The electrode 3a is formed in contact with the lower surface of the solid electrolyte body 5 so as to face the inner space 7. The electrode 3b is formed in contact with the upper surface of the solid electrolyte body 5 so as to face the second reference gas space 17. The electrodes 3a and 3b of the sensor cell 3 are disposed downstream from the second oxygen pump 4 within the inner space 7. In this embodiment, the electrode 3b of the sensor 3 is formed integrally with the electrode 4b of the second pump cell 4.

Preferably, the electrode 2a of the first oxygen pump cell 2 and the electrode 4a of the second oxygen pump cell 4 are made of material which is low in NOx decomposition activity to suppress decomposition of NOx contained in the measurement gas.

In this embodiment, a porous cermet electrode containing Pt and Au as major metal components is used for them. Preferably, the content of Au is in the range from 0.5 to 5 weight %. It is also preferable that the electrode 3a of the sensor cell 3 is made of material having high NOx decomposition activity. In this embodiment, a porous cermet electrode containing Pt and Rh as major metal components is used for it. Preferably, the content of Rh is in the range from 10 to 50 weight %. It is preferable to use a Pt porous cermet electrode for the electrode 2b of the first oxygen pump cell 2, the electrode 4b of the second oxygen pump cell 4 and the electrode 3b of the sensor cell 3.

As shown in FIG. 2, these electrodes 2a, 2b, 4a, 4b, 3a and 3b are integrally formed with leads 2c, 2d, 4c, 3c and 3d, respectively, for receiving electric signals from these electrodes. These leads are made of cermet material containing noble metal such as Pt and ceramics such as zirconia as major components. It is preferable that the portions of the solid electrolyte bodies 5 and 6 other than the portions formed with the electrodes, particularly the portion formed with the lead 2c is coated with an insulating layer such as an alumina layer.

The heater 12 is formed by patterning a heater electrode 14 onto a heater sheet 13 made of alumina, and forming an alumina layer 15 on the upper surface (the surface on the side of the spacer 9) of the heater electrode 14 for insulation. In this embodiment, as a material of the heater electrode 14, a cermet of Pt and ceramics such as alumina is used. The heater 12 generates heat when the heater electrode 14 is supplied with a current from outside to heat the cells 2, 3 and 4 up to their activation temperatures.

As shown in FIG. 2, the cells 2, 3 and 4, and the heater electrode 14 are connected to the terminals P at the sensor proximal end portion through holes SH formed in the proximal end portions of the solid electrolyte bodies 5 and 6, spacers 8, 9 and 91 and the heater sheet 13. As shown in FIG. 1B, the terminals P are connected with lead wires H8 by crimping or brazing through a connector to enable signal exchange between an external circuit and each of the cells 2, 3 and 4, and the heater 12.

Each of the solid electrolyte bodies 5 and 6, the spacers 8, 9 and 91, the alumina layer 15 and the heater sheet 13 can be formed into a sheet-like shape by the doctor blade method or molding method. Each of the respective electrodes, lead 2c and terminals P can be formed by the screen printing method. The respective sheets are stacked and baked to be integrated.

Next, the operation of the gas sensor element 1 having the above described structure is explained. Referring to FIG. 1A, the exhaust gas as a measurement gas is introduced into the inner space 7 through the porous diffusion resistor 11. The amount of the measurement gas introduced is determined depending on the diffusion resistance of the porous diffusion resistor 11, When a voltage is applied between the electrodes 2a and 2b of the first oxygen pump cell 2 and between the electrodes 4a and 4b of the second oxygen pump cell 4 such that the electrodes 2b and 4b on the side of the first and second reference gas spaces 16 and 17 become positive, the oxygen contained in the measurement gas is reduced to oxygen ions on the electrodes 2a and 4a on the side of the inner space 7, and discharged to the sides of the electrodes 2b and 4b by pumping action.

On the other hand, when a voltages is applied such that the electrodes 2a and 4a on the side of the inner space 7 become positive, the oxygen is reduced to oxygen ions on the electrodes 2b and 4b on the sides of the first and second reference gas spaces 16 and 17, and discharged to the sides of the electrodes 2a and 4a by pumping action. By applying the voltage depending on the oxygen concentration so that the oxygen pump current becomes a limiting current determined from a relationship between the voltage applied to the oxygen pump cell and the current of the oxygen pump cell obtained in advance, the oxygen concentration in the inner space 7 can be controlled at a predetermined low level.

A predetermined voltage (0.4 V, for example) is applied between the electrodes 3a and 3b of the sensor cell 3 such that the electrode 3b on the side of the second reference gas space 17 becomes positive. Since the electrode 3a is a Pt—Rh cermet electrode which, is active in decomposing NOx as a specific gas component, oxygen and NOx are reduced to oxygen ions on the electrode 3a on the side of the inner space 7, and discharged to the side of the electrode 3b by pumping action. Since the current value increases with the increase of concentration of the NOx when NOx exists in the measurement gas, the concentration of NOx can be determined from the current value.

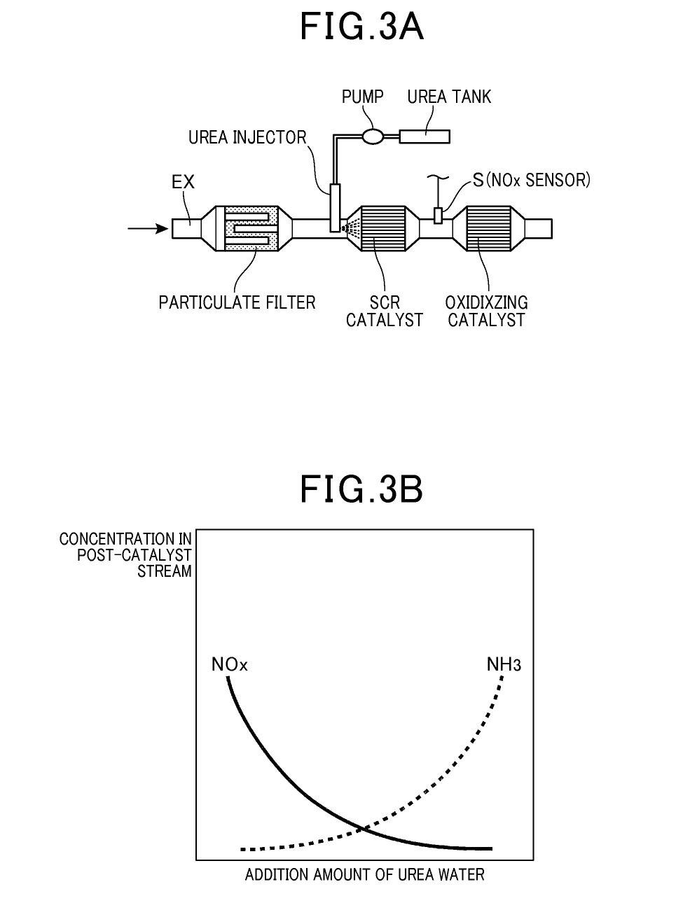

As shown in FIG. 3A, the NOx sensor S including the gas sensor element 1 can be advantageously used in a NOx purifying system, mounted on an exhaust gas passage EX of a vehicle engine, for example, an exhaust gas purifying system including a urea SCR system. The exhaust gas passage EX is provided with a particulate filter for removing PM (particulate matter) from the exhaust gas, a NOx purifying catalyst (SCR catalyst) of the selective reduction type and an oxidising catalyst for preventing slip of NH₃, which are disposed in this order from the upstream side. An injector for injecting urea water into the exhaust gas passage EX is disposed upstream of the SCR catalyst so that NH₃ produced as reducing agent through decomposition of added urea selectively reduces NOx in the exhaust gas to harmless N₂ and H₂O at the SCR catalyst. The injector is supplied with urea water stored in a urea water tank by a pump.

In this urea SCR system, the whole NOx in the exhaust gas is rendered harmless when an appropriate amount of urea water is injected. As shown in FIG. 3B, if an amount of injected urea water is excessive for an amount of NOx to be removed, harmful NH₃ is discharged, on the other hand, if it is insufficient for an amount of NOx to be removed, NOx is discharged. Accordingly, it is necessary to control an injection amount of urea water at an appropriate value. In this urea SCR system, the NOx sensor is disposed downstream from the SCR catalyst to measure the NOx concentration and the NH₃ concentration of the exhaust gas having been subjected to the NOx purification using urea water. An injection amount of urea wafer is feedback-controlled such that the sum of the NOx concentration and the NH₃ concentration in the post-catalyst stream becomes minimum to realize optimum exhaust gas purification by the urea SCR system.

Hence, the gas sensor element 1 of the NOx sensor is required to be capable of measuring the NH₃ concentration in addition to the NOx concentration of the exhaust gas. When an injection amount of urea water is excessive, surplus NH₃ is introduced into the gas sensor element 1 after the NOx purification, and oxidized by oxygen present in the inner space 7 to produce NOx which is to be measured in the sensor cell 3. Accordingly, it does not necessarily have to distinguish between the NOx concentration and the NH₃ concentration based on the sensor signal, if an optimum control point is achieved by the feedback control based on FIG. 3B.

The gas sensor element 1 exhibits high oxygen pumping capability because it includes the first and second pump cells 2 and 4 disposed facing each other across the inner space 7, and is controlled such that the oxygen concentration in the inner space 7 is kept constant. Further, since the first and second reference gas spaces 16 and 17 are in communication with the atmosphere, it is possible to quickly evacuate oxygen ions from the inner space 7 to the first and second reference gas spaces 16 and 17 and vice versa regardless of the exhaust gas being rich or lean.

This makes it possible that the oxygen concentration in the inner space 7 is kept uniform and at a constant low level. Accordingly, according to this embodiment having the simple structure where the sensor cell 3 is disposed facing the inner space 7, NOx concentration can be measured with a high degree of accuracy. Further, since it is not necessary to dispose the sensor cell 3 in an inner space other than the inner space 7 and to provide communication between these inner spaces through another diffusion resistor, characteristic variation due do individual variation in the diffusion resistor shape and inner space shape can be reduced.

Meanwhile, it is practically impossible to completely eliminate element-to-element variation in the shape of the porous diffusion resistor 11 even in the gas sensor element 1 of the present invention. Accordingly, there is sensor-to-sensor variation in the NOx concentration dependency of the output current (that is, the NOx sensitivity) of the sensor 3. Hence, to eliminate the sensor-to-sensor variation to provide a further accurate NOx sensor, it is necessary to perform, calibration of the sensor output for every sensor. Conventionally, the sensor output is calibrated using a NOx gas of a predetermined concentration as a calibration gas. However, since NOx gas is expensive and harmful, and in addition, appropriate safety facilities are required to handle NOx gas, the cost for performing the calibration is high.

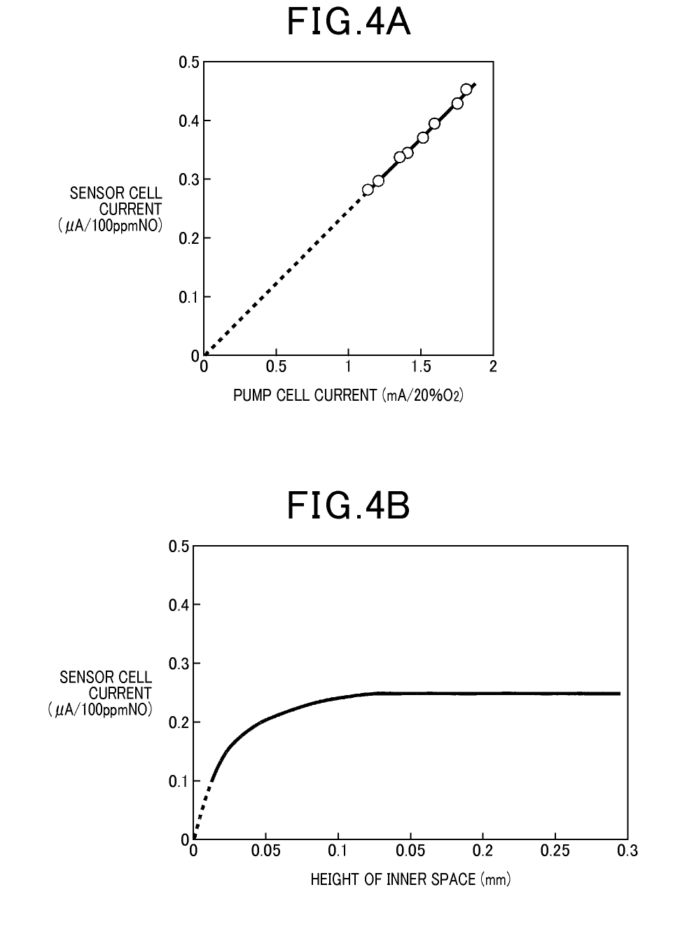

FIG. 4A is a graph plotting a relationship between the pump cell current for 20% O₂ and the sensor cell current for 100 ppm NOx for each of eight gas sensor elements 1. As shown in this graph, a proportional relationship exists between the O₂ concentration dependency of the pump cell current (that is, the O₂ sensitivity) and the NOx concentration dependency of the sensor cell current (that is, the NOx sensitivity). Accordingly, this proportional relationship makes if possible to calibrate the NOx sensitivity of the sensor cell 3 by measuring the oxygen pump cell current when an oxygen gas of a predetermined concentration is used as the calibration gas. The atmosphere may be used as the oxygen gas of the predetermined concentration.

In this case, the sensor output can be calibrated without using expensive and harmful NOx gas.

However, it is preferable that the diffusion resistance between the pump cell and the sensor cell is sufficiently smaller than that of the porous diffusion resistor 11 in order to enhance the correlation between the pump cell current and the sensor cell current. FIG. 4B shows a relationship between the height of the inner space 7 and the sensor cell current. In this embodiment, the sensor cell current is measured for each of different values of the height of the inner space 7 when the width and length of the inner space 7 are 3.0 mm and 8.0 mm, respectively, and the porous diffusion resistor 11 is made such that the pump cell current is 1 mA when the oxygen concentration is 20%.

When the height of the inner space 7 is small, the sensor cell current is small because not only the porous resistance of the porous diffusion resistor 11 but also the diffusion resistance within the inner space 7 contributes to the value of the sensor cell current. As the height of the inner space 7 increases, contribution of the diffusion resistance within the inner space 7 to the value of the sensor cell current becomes small, and the sensor cell current becomes to be determined depending only on the diffusion resistance of the porous diffusion resistor 11. The porous diffusion resistor 11 is a diffusion resistor common to both the pump cell current and the sensor cell current. However, the contribution of the diffusion resistance due to the inner space 7 to the sensor cell current is larger than to the pump cell current. Since the shape of the inner space 7 varies due to manufacturing variation, the contribution of the inner space 7 to the sensor cell current should be small to enhance the correlation between the pump cell current and the sensor cell current and to ensure accurate calibration.

FIG. 4B shows that if the height of the inner space 7 is larger than 0.1 mm, the sensor cell current is hardly affected by the inner space 7. Accordingly, the height of the inner space 7 is preferably larger than 0.1 mm so that the gas sensor 1 exhibits a high degree of measuring accuracy by performing the above calibration.

Incidentally, when the height of the inner space 7 is increased and the diffusion resistance between the pump cell and the sensor cell is made sufficiently smaller than, that of the porous diffusion resistor 11, the volume of the inner space 7 becomes relatively large for the same value of the diffusion resistance of the porous diffusion resistor 11. In this case, it is necessary to ensure sufficient oxygen pumping capacity to control the oxygen concentration in the inner space 7. According to this embodiment, since the first and second oxygen, pump cells 2 and 4 of the gas sensor element 1 are disposed on the upper and lower surfaces of the inner space 7, respectively, it is possible to increase the oxygen pumping capacity to thereby keep the oxygen concentration in the inner space 7 uniform.

In this embodiment, the electrode of the first oxygen pump cell 2 and the electrode 4b of the second oxygen pump cell 4 face the first reference gas space 16 and the second reference gas space 17, respectively, and also face the atmosphere as the common reference oxygen concentration gas. Accordingly, since the electrodes 2b and 4b can be regarded in the same potential within a control circuit, it is possible to stably pump oxygen from the atmosphere into the inner space 7 to keep the oxygen concentration at a predetermined low level even in the rich atmosphere.

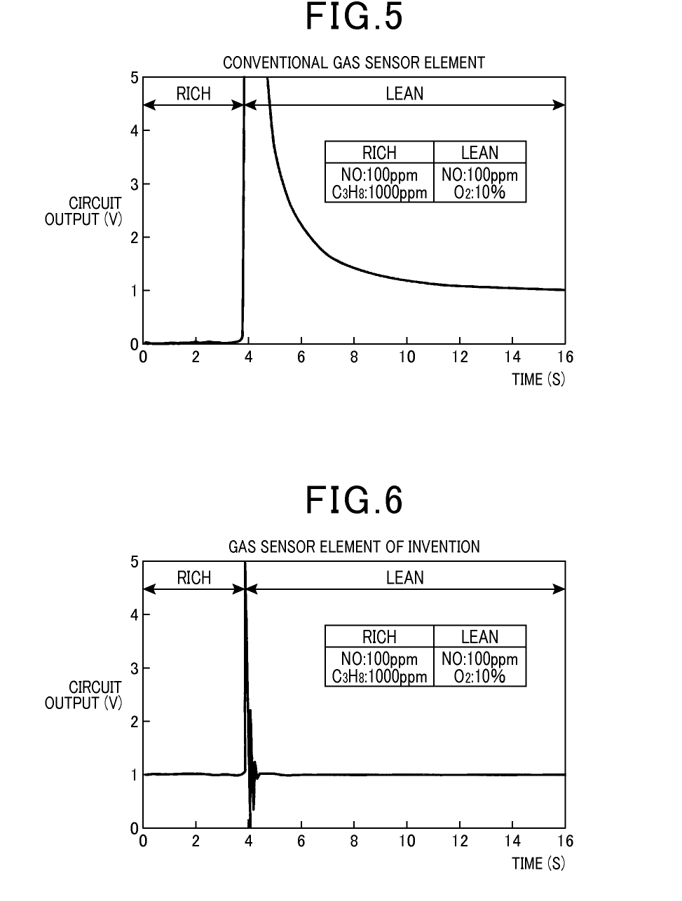

FIG. 5 is a diagram showing variation with time of the sensor output of the conventional gas sensor element described in the foregoing Patent document 3 during transition from exhaust gas rich atmosphere to exhaust gas lean atmosphere. FIG. 6 is a diagram, showing variation with time of the sensor output of the gas sensor element according to the first embodiment during transition from exhaust gas rich atmosphere to exhaust gas lean atmosphere. Their control circuits are adjusted to output 1 V when the NO concentration is 100 ppm. As shown in FIG. 5, the output of the control circuit of the conventional gas sensor element is not normal (not equal to 1 V) in the rich atmosphere, because the oxygen concentration in the inner space is not controlled in the rich atmosphere. Further, it takes a long time before the output of the control circuit becomes normal after the rich atmosphere is changed to the lean atmosphere. On the other hand, as shown in FIG. 6, the output of the control circuit of the gas sensor element of this embodiment is normal (equal to 1 V) in the rich atmosphere. Further, the output quickly becomes normal after the rich atmosphere is changed to the lean atmosphere.

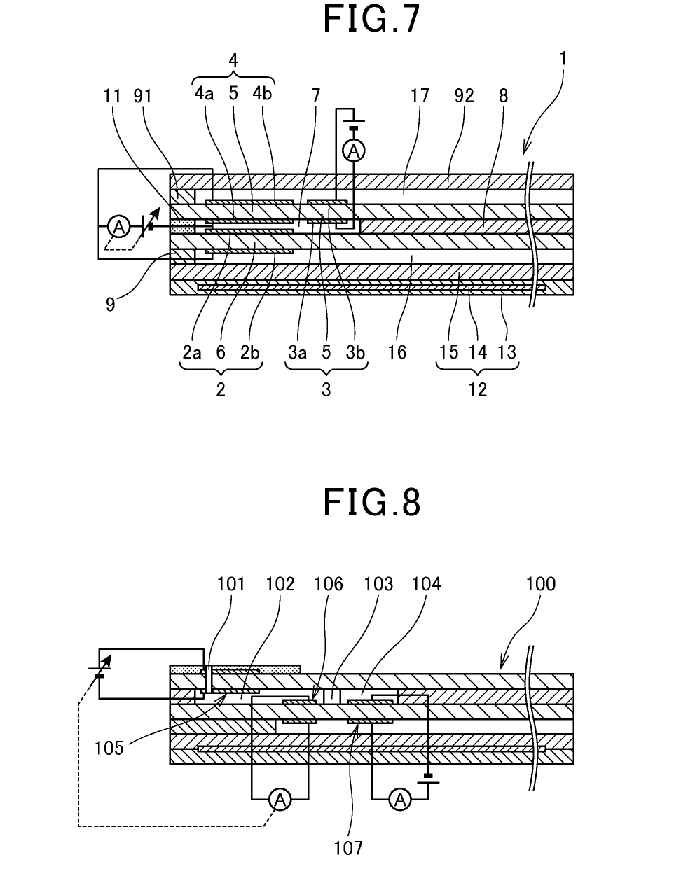

FIG. 7 is a schematic cross-sectional view of the distal end portion of a gas sensor element 1 according to a second embodiment of the invention.

In FIG. 7, the components which are the same as or equivalent to those of the gas sensor element 1 according to the first embodiment are indicated by the same reference numerals or characters, and explanations thereof are omitted. The basic structure of the second embodiment is the same as that of the first embodiment. That is, the gas sensor element 1 according to the second embodiment is formed by stacking, in order, the sheet-like solid electrolyte body 6 for constituting the first oxygen pump cell 2, the sheet-like solid electrolyte body 5 for constituting the second oxygen pump cell 4 and the sensor cell 3, the sheet-like spacer 8 for forming the inner space 7, the sheet-like spacers 9 and 91 for forming the first reference gas space 16 and the second reference gas space 17, and the heater 12 for heating these components in this order.

In the second embodiment, the electrode 4b of the second pump cell 4 and the electrode 3b of the sensor cell 3 are formed separately from each other. Accordingly, since the sensor cell 3 is hard to be affected by the second oxygen pump cell 4, the measuring accuracy is increased.

As described above, according to the present invention, a gas sensor element satisfying both high measurement accuracy and low manufacturing cost can be provided. The gas sensor element of the present invention can be used not only as a NOx sensor mounted on an exhaust system of an internal combustion engine to control injection amount of urea water, but also as a NOx sensor for various types of NOx purifying systems to monitor NOx concentration downstream from a NOx storage and reduction catalyst, or to control recovery of the NOx storage and reduction catalyst, for example.

The gas sensor element of the present invention can be used to detect or measure not only NOx but also SOx, O₂ and CO₂.

The above explained preferred embodiments are exemplary of the invention of the present application which is described solely by the claims appended below. It should be understood that modifications of the preferred embodiments may be made as would occur to one of skill in the art.

What is claimed is:

1. A gas sensor element comprising:
an inner space into which a measurement gas is introduced through a diffusion resistor;
a first oxygen pump cell including a first solid electrolyte body having oxygen ion conductivity, and first and second electrodes formed on both opposite surfaces of the first solid electrolyte body, the first electrode facing the inner surface so that oxygen can be introduced into or discharged from the inner space to adjust oxygen concentration in the inner space by applying a voltage between the first and second electrodes;
a second oxygen pump cell including a second solid electrolyte body having oxygen ion conductivity, and third and fourth electrodes formed on both opposite surfaces of the second solid electrolyte body, the third electrode facing the inner surface so that oxygen can be introduced into or discharged from the inner space to adjust the oxygen concentration in the inner space by applying a voltage between the third and fourth electrodes; and
a sensor cell including a third solid electrolyte body having oxygen ion conductivity, and fifth and sixth electrodes formed on both opposite surfaces of the third solid electrolyte body, the fifth electrode facing the inner surface, a current flowing between the fifth and sixth electrode being an output of the gas sensor element indicative of concentration of a specific gas component contained in the measurement gas;
wherein
the first electrode and the third electrode are disposed opposite to each other across from the inner space, and
the second electrode and fourth electrode are exposed to a common reference oxygen concentration gas.

2. The gas sensor element according to claim 1, wherein
the first solid electrolyte body and the second solid electrolyte body are stacked so as to sandwich the inner space,
the second electrode is formed on the first solid electrolyte body so as to face a first reference gas space opposite to the inner space, and
the fourth electrode is formed on the second electrolyte body so as to face the second reference gas space opposite to the inner space,
the common reference oxygen concentration gas being introduced into the first and second reference gas spaces from a common reference-oxygen-concentration gas existing space.

3. The gas sensor element according to claim 1, wherein the common reference oxygen concentration gas is an atmosphere.

4. The gas sensor element according to claim 1, wherein the specific gas component contained in the measurement gas is nitrogen oxide.

5. The gas sensor element according to claim 1, wherein the height of the inner space is larger than 0.1 mm.

6. The gas sensor element according to claim 1, wherein the sensor cell is disposed downstream from the first and second oxygen pump cells with respect to flow of the measurement gas.

7. A gas sensor for an internal combustion engine including the gas sensor element as recited in claim 1 in which the measurement gas is exhaust gas of the internal combustion engine.
